(19) United States
(12) Patent Application Publication
(10) Pub. No.: US 2018/0275547 A1
(43) Pub. Date: Sep. 27, 2018

(54) TWO-COMPONENT DEVELOPER

(71) Applicant: Konica Minolta, Inc., Tokyo (JP)

(72) Inventors: Makoto NOMIYA, Tokyo (JP); Yasuko UCHINO, Tokyo (JP); Tomomi OSHIBA, Tokyo (JP)

(21) Appl. No.: 15/926,237

(22) Filed: Mar. 20, 2018

(30) Foreign Application Priority Data
Mar. 22, 2017 (JP) 2017-055988

(51) Int. Cl. G03G 9/113; G03G 9/087

(52) U.S. Cl. CPC G03G 9/1133; G03G 9/08711; G03G 9/08755; G03G 9/1136

(57) ABSTRACT

A two-component developer includes: a toner containing a binder resin and a layered inorganic mineral; and a carrier containing core material particles and a coating layer with which at least a part of surfaces of the core material particles is coated, the coating layer containing a coating resin, the coating resin containing a resin A having a constituent unit derived from a (meth)acrylate monomer, and the (meth)acrylate monomer containing an alicyclic (meth)acrylate monomer.

The entire disclosure of Japanese patent Application No. 2017-055988, filed on Mar. 22, 2017, is incorporated herein by reference in its entirety.

### BACKGROUND

### Technological Field

The present invention relates to a two-component developer. In more detail, the present invention relates to a two-component developer used for electrophotographic image formation.

### Description of the Related art

In recent years, in the field of on-demand printing, printing by an electrophotographic system has come to be used. As compared with the previous use in offices, the printing volume has been increased, and there has been an increasing demand for continuously outputting high-quality images stably even in mass printing.

If mass printing for a long period of time is performed, image defects occur. As the cause, there are an image defect (generation of streaks) due to cleaning failure of a photoreceptor by toner slipping, an image density change due to changes in charge amount by changes in use environment, an image defect (fog) due to toner cracks, and the like, and the necessity of a technique for suppressing these problems has been increased more and more.

As one of the means for solving the problems of the image defects as described above, investigation of a technique in which by adding a layered inorganic mineral into a toner, the releasability of the toner from a photoconductor is improved, and the cleaning performance of the photoreceptor is improved has proceeded.

For example, in JP 2011-191725 A, a toner characterized in that the toner contains at least a precursor of a binder resin (A) and/or a binder resin (B), wax, a layered inorganic mineral, and a tertiary amine, the wax is a petroleum wax having a weight reduction of 10% by mass or less at 165° C. and a melting point of 60 to 95° C., the layered inorganic mineral is a layered inorganic mineral obtained by modifying at least a part of ions between layers with organic ions, the toner has an average circularity of 0.955 to 0.975, and further a tertiary amine compound remaining in the toner is 0.1 wt % or less has been disclosed.

Further, in JP 2013-218287 A, a developer characterized in that the developer contains a toner and a carrier, the toner contains a binder resin, a coloring agent, and an organic-modified layered inorganic compound in which at least a part of ions existing between the layers are substituted with organic ions, the binder resin contains a crystalline resin having a urethane bond and/or a urea bond in the main chain, a surface of a core material in the carrier is coated with a coating layer, and the coating layer contains a condensate of a melamine resin and/or a guanamine resin and an acrylic resin having a hydroxyl group has been disclosed.

However, according to the investigation of the present inventors, it has been found that in the technique described in JP 2011-191725 A, there is a problem that the interface between the layered inorganic mineral and the binder resin existing inside the toner is weak to mechanical stress, toner cracks are generated, and image defects are generated. Further, it has been found that in the technique described in JP 2013-218287 A, there is a problem that the environmental dependence of the charge amount increases (that is, the charge environmental stability is lowered).

Further, according to the investigation of the present inventors, it has also been found that in a case where the toner and carrier described in JP 2011-191725 A and JP 2013-218287 A are used, it is insufficient to suppress an image defect (generation of streaks) due to cleaning failure of a photoreceptor.

### SUMMARY

Accordingly, the present invention has been made in view of such circumstances, and an object of the present invention is to provide a two-component developer that improves the cleaning performance of a photoreceptor, hardly generates toner cracks, is excellent in the charge environmental stability, and can output high-quality images stably even in mass printing.

To achieve the abovementioned object, according to an aspect of the present invention, a two-component developer reflecting one aspect of the present invention comprises:

a toner containing a binder resin and a layered inorganic mineral; and

a carrier containing core material particles and a coating layer with which at least a part of surfaces of the core material particles is coated,

the coating layer containing a coating resin,

the coating resin containing a resin A having a constituent unit derived from a (meth)acrylate monomer, and

the (meth)acrylate monomer containing an alicyclic (meth)acrylate monomer.

### DETAILED DESCRIPTION OF EMBODIMENTS

Hereinafter, one or more embodiments of the present invention will be described in detail. However, the scope of the invention is not limited to the disclosed embodiments.

[Two-component Developer]

According to the present invention, there is provided a two-component developer including a toner containing a binder resin and a layered inorganic mineral; and a carrier containing core material particles and a coating layer with which at least a part of surfaces of the core material particles is coated, in which the coating layer contains a coating resin, the coating resin contains a resin A having a constituent unit derived from a (meth)acrylate monomer, and the (meth)acrylate monomer contains an alicyclic (meth)acrylate monomer, is provided. The two-component developer according to an aspect of the present invention, which has such a constitution, improves the cleaning performance of a toner on a photoreceptor, hardly generates toner cracks, is excellent in the charge environmental stability, and can output high-quality images stably even in mass printing.

Although the mechanism by which such an effect is exerted is not completely clear, the following mechanism is presumed. Note that the present invention is not limited to the following mechanism at all.

The toner constituting the two-component developer of the present invention becomes a toner that is easily cleaned (that is, easily released from the photoconductor) by the presence of a layered inorganic mineral in the vicinity of a surface of the toner, with a slight protrusion in a part where the layered inorganic mineral is present, and can improve the cleaning performance of the toner on a photoreceptor. Further, the carrier constituting the two-component developer of the present invention enhances the hydrophobicity and improves the charge environmental stability by containing a resin A that has a constituent unit derived from an alicyclic (meth)acrylate monomer in the coating layer. Furthermore, when an alicyclic group (alicyclic alkyl group) is present in the coating layer of the carrier (that is, a bulky part is present in a part of the molecule), the stress relaxation effect works at the time of collision of the toner with the carrier, and the impact can be reduced. Therefore, the stress to the toner becomes weakened, toner cracks can be prevented, and image defects due to the toner cracks can be reduced.

Hereinafter, the two-component developer of the present invention will be described separately for each element. Note that in the present specification, the expression “X to Y” is used with the meaning of including the numerical values (X and Y) described before and after the “to” as the lower limit value and the upper limit value, respectively. Further, unless otherwise noted, operations and measurements of properties and the like are performed under the conditions of room temperature (25° C.)/relative humidity 40 to 50% RH. Moreover, the term “(meth)acrylate” includes both of methacrylate and acrylate.

[Toner]

The toner of the two-component developer according to the present invention contains at least a binder resin, and a layered inorganic mineral.

In addition, in the following description, the expression “toner base particles” means particles that contain at least a binder resin and a layered inorganic mineral, and contain other additive agents (internal additives) as needed. By adding an external additive into the toner base particles, the toner is completed.

The toner base particles are not particularly limited, and any kind of toner base particles can be used. As the method for producing the toner base particles, there are no particular limitations, and a pulverization method, a suspension polymerization method, a mini-emulsion polymerization aggregation method, an emulsion polymerization aggregation method, a dissolution suspension method, a polyester molecule elongation method, other known methods, and the like can be mentioned.

Hereinafter, each component constituting the toner will be described.

<Constituent Component of Toner>

(Binder Resin)

As the binder resin constituting toner base particles, various known resins, for example, a vinyl resin such as a styrene resin, a (meth) acrylic resin, a styrene-(meth) acrylic copolymer resin, and an olefin resin, a polyester resin, a polyamide resin, a polycarbonate resin, a polyether resin, a polyvinyl acetate resin, a polysulfone resin, an epoxy resin, a polyurethane resin, a urea resin, and the like may be used. In addition, these may be used singly, or in combination of two or more kinds thereof. As the binder resin, amorphous and/or crystalline ones may be used, or both thereof may be used in combination.

In one preferred embodiment of the present invention, the binder resin contains a styrene-(meth)acrylic copolymer resin, and a polyester resin. Hereinafter, the styrene-(meth)acrylic copolymer resin and the polyester resin will be described.

The styrene-(meth)acrylic copolymer resin is formed by addition polymerization of at least a styrene monomer and a (meth)acrylic acid monomer. The styrene monomer referred to herein includes not only the styrene represented by the structural formula of CH₂═CH—C₆H₅, but also ones with a structure having a known side chain or functional group in the styrene structure. Further, the (meth)acrylic monomer referred to herein includes not only the acrylic acid represented by CH₂═CHCOOR (R is —H or an alkyl group) or an ester compound thereof and the methacrylic acid or an ester compound thereof, but also an ester compound having a known side chain or functional group in the structure such as an acrylic acid ester derivative and a methacrylic acid ester derivative, or a salt thereof.

An example of a styrene monomer and a (meth)acrylic monomer, which can form a styrene-(meth)acrylic copolymer resin will be described below.

Specific examples of the styrene monomer include styrene, o-methyl styrene, m-methyl styrene, p-methyl styrene, α-methyl styrene, p-phenyl styrene, p-ethyl styrene, 2,4-dimethyl styrene, p-t-butyl styrene, p-n-hexyl styrene, p-n-octyl styrene, p-n-nonyl styrene, p-n-decyl styrene, and p-n-dodecyl styrene. These styrene monomers may be used alone, or in combination of two or more kinds thereof.

Further, specific examples of the (meth)acrylic monomer include a (meth)acrylic acid ester compound such as methyl (meth)acrylate, ethyl (meth)acrylate, isopropyl (meth)acrylate, n-butyl (meth)acrylate, t-butyl (meth)acrylate, isobutyl (meth)acrylate, n-octyl (meth)acrylate, 2-ethylhexyl (meth)acrylate, stearyl (meth)acrylate, lauryl (meth)acrylate, phenyl (meth)acrylate, diethylaminoethyl (meth)acrylate, and (2-dimethylamino)ethyl methacrylate; a compound having a carboxyl group such as acrylic acid, methacrylic acid, maleic acid, itaconic acid, cinnamic acid, fumaric acid, maleic acid monoalkyl ester, and itaconic acid monoalkyl ester; a compound having a hydroxyl group such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate, and a (meth)acrylic acid ester derivative such as a sodium salt of a sulfuric acid ester of a methacrylic acid-ethylene oxide adduct. These monomer compounds may be used alone, or in combination of two or more kinds thereof.

The method for producing the styrene-(meth)acrylic copolymer resin is not particularly limited, and a method in which polymerization is performed by a known polymerization technique such as bulk polymerization, solution polymerization, an emulsion polymerization method, a mini-emulsion method, or a dispersion polymerization method using an arbitrary polymerization initiator such as a peroxide, a persulfide, a persulfate, or an azo compound, which is usually used for polymerization of the above monomers, can be mentioned. In addition, for the purpose of adjusting the molecular weight, a chain transfer agent that is generally used can be used. As the chain transfer agent, there are no particular limitations, and for example, an alkyl mercaptan such as n-octyl mercaptan, and a mercapto fatty acid ester can be mentioned.

The content of the styrene-(meth)acrylic copolymer resin is preferably 5.0 to 15.0% by mass relative to the toner base particles.

Further, as the polyester resin contained in a binder resin, a urea-modified polyester resin, and/or an unmodified polyester resin may be used.

The unmodified polyester resin that can be used in the present invention is an unmodified polyester resin obtained usually by polycondensation of alcohol and carboxylic acid. Examples of the alcohol include glycols such as ethylene glycol, diethylene glycol, triethylene glycol, and propylene glycol; etherified bisphenols such as 1,4-bis(hydroxymethyl) cyclohexane, and bisphenol A, other dihydric alcohol monomers, and trihydric or higher polyhydric alcohol monomers. In addition, examples of the carboxylic acid include a divalent organic acid monomer such as maleic acid, fumaric acid, phthalic acid, isophthalic acid, terephthalic acid, succinic acid, and malonic acid; and a trivalent or higher polyvalent carboxylic acid monomer such as 1,2,4-benzene tricarboxylic acid, 1,2,5-benzene tricarboxylic acid, 1,2,4-cyclohexane tricarboxylic acid, 1,2,4-naphthalene tricarboxylic acid, 1,2,5-hexane tricarboxylic acid, 1,3-dicarboxyl-2-methylene carboxy propane, and 1,2,7,8-octane tetracarboxylic acid. The content of the unmodified polyester resin is preferably 50 to 75% by mass relative to the toner base particles.

Further, hereinafter, the urea-modified polyester resin for use in the present invention will be described.

The method for producing the toner and toner base particles for use in the present invention is not particularly limited, and can include a highly polymerizing step in which a polymer having a site capable of reacting with a compound having an active hydrogen group in an organic solvent is contained, and the polymer is reacted with the compound having an active hydrogen group at the time of granulation in an aqueous medium. As the polymer having a site capable of reacting with a compound having an active hydrogen group, an isocyanate group-containing polyester prepolymer is preferred, and as the compound having an active hydrogen group, amines are preferred. The polyester prepolymer and the amines are reacted to obtain a urea-modified polyester structure through a highly polymerizing step.

The polyester prepolymer containing an isocyanate group can be obtained by reacting a polyester that is a polycondensate of polyol and polycarboxylic acid and has an active hydrogen group further with a polyisocyanate. In this case, examples of the active hydrogen group possessed by polyester include a hydroxyl group (an alcoholic hydroxyl group, and a phenolic hydroxyl group), an amino group, a carboxyl group, and a mercapto group, and among them, an alcoholic hydroxyl group is preferred.

Examples of the polyol include a diol, and a trihydric or higher polyol, and a diol alone, or a mixture of a diol and a small amount of a trihydric or higher polyol is preferred. Examples of the diol include an alkylene glycol (ethylene glycol, 1,2-propylene glycol, 1,3-propylene glycol, 1,4-butanediol, 1,6-hexanediol, and the like); an alkylene ether glycol (diethylene glycol, triethylene glycol, dipropylene glycol, polyethylene glycol, polypropylene glycol, polytetramethylene ether glycol, and the like); an alicyclic diol (1,4-cyclohexanedimethanol, hydrogenated bisphenol A, and the like); bisphenols (bisphenol A, bisphenol F, bisphenol S, and the like); an alkylene oxide (ethylene oxide, propylene oxide, butylene oxide, and the like) adduct of the above-described alicyclic diol; and an alkylene oxide (ethylene oxide, propylene oxide, butylene oxide, and the like) adduct of the above-described bisphenols. Among them, an alkylene glycol having 2 to 12 carbon atoms, and an alkylene oxide adduct of bisphenols are preferred, and an alkylene oxide adduct of bisphenols is particularly preferred. Examples of the trihydric or higher polyol include tri- to octa-hydric or higher polyhydric aliphatic alcohol (glycerin, trimethylolethane, trimethylol propane, pentaerythritol, sorbitol, and the like); trihydric or higher phenols (trisphenol PA, phenol novolak, cresol novolak, and the like); and an alkylene oxide adduct of the above-described trihydric or higher polyphenols.

Examples of the polycarboxylic acid include dicarboxylic acid, and trivalent or higher polycarboxylic acid, and a dicarboxylic acid alone, and a mixture of a dicarboxylic acid and a small amount of a trivalent or higher tricarboxylic acid are preferred. Examples of the dicarboxylic acid include an alkylene dicarboxylic acid (succinic acid, adipic acid, sebacic acid, and the like); an alkenylene dicarboxylic acid (maleic acid, fumaric acid, and the like); and an aromatic dicarboxylic acid (phthalic acid, isophthalic acid, terephthalic acid, naphthalene dicarboxylic acid, and the like). Among them, an alkenylene dicarboxylic acid having 4 to 20 carbon atoms, and an aromatic dicarboxylic acid having 8 to 20 carbon atoms are preferred. Examples of the trivalent or higher polycarboxylic acid include an aromatic polycarboxylic acid having 9 to 20 carbon atoms (trimellitic acid, pyromellitic acid, and the like). Note that as the polycarboxylic acid, an acid anhydride or lower alkyl ester (methyl ester, ethyl ester, isopropyl ester, or the like) of the above-described ones may be used to react with the polyol.

Examples of the polyisocyanate include an aliphatic polyisocyanate (tetramethylene diisocyanate, hexamethylene diisocyanate, 2,6-diisocyanatomethyl caproate, and the like); an alicyclic polyisocyanate (isophorone diisocyanate, cyclohexylmethane diisocyanate, and the like); an aromatic diisocyanate (tolylene diisocyanate, diphenylmethane diisocyanate, and the like); an araliphatic diisocyanate (α,α,α′,α′-tetramethylxylylene diisocyanate, and the like); isocyanurates; one obtained by blocking the polyisocyanate with a phenol derivative, oxime, caprolactam or the like; and two or more kinds thereof in combination.

As the amines, polyamine, and/or amines having an active hydrogen-containing group are used. In this case, the active hydrogen-containing group includes a hydroxyl group, and a mercapto group. Examples of the amines include diamine, trivalent or higher polyamine, amino alcohol, amino mercaptan, amino acid, and one obtained by blocking the amino group of these amines. Examples of the diamine include an aromatic diamine (phenylene diamine, diethyltoluenediamine, 4,4′-diaminodiphenylmethane, and the like); an alicyclic diamine (4,4′-diamino-3,3′-dimethyl dicyclohexylmethane, diamine cyclohexane, isophoronediamine, and the like); and an aliphatic diamine (ethylenediamine, tetramethylenediamine, hexamethylenediamine, and the like). Examples of the trivalent or higher polyamine include diethylenetriamine, and triethylenetetramine. Examples of the amino alcohol include ethanol amine, and hydroxyethyl aniline. Examples of the amino mercaptan include amino ethyl mercaptan, and aminopropyl mercaptan. Examples of the amino acid include aminopropionic acid, and aminocaproic acid. As the one obtained by blocking an amino group of these amines, a ketimine compound, an oxazoline compound, and the like obtained from the amines and ketones (acetone, methyl ethyl ketone, methyl isobutyl ketone, and the like) can be mentioned. Among these amines, the one obtained by blocking an amino group of the amines is preferred.

The content of a urea-modified polyester resin is preferably 5.0 to 20.0% relative to the total mass of the binder resin.

(Layered Inorganic Mineral)

The toner of the present invention contains a layered inorganic mineral. By adding a layered inorganic mineral, the toner can be made deformed, and the cleaning performance of a photoreceptor can be improved. It is considered that in the preferred method for producing a toner described later in which a toner material liquid is emulsified in an aqueous medium in the presence of a surfactant and resin fine particles, the layered inorganic mineral in the toner material liquid moves to the interface between the organic solvent and/or monomer oil droplet and the aqueous solvent at the time of emulsification, and gathers in the vicinity of a surface of the emulsified dispersion (reactant). As a result, it is considered that the layered inorganic mineral is present in the vicinity of a surface of the toner, unevenness is formed, the releasability of the toner from a photoreceptor is improved, and the cleaning performance of the photoreceptor is improved.

The expression “layered inorganic mineral” in the present invention means an inorganic mineral made by superimposing some layers having a thickness of several nm. As the layered inorganic mineral, there are no particular limitations, and may be appropriately selected depending on the intended purpose. Examples of the layered inorganic mineral include a smectite group clay mineral (montmorillonite, saponite, hectorite, and the like), a kaolin group clay mineral (kaolinite, and the like), bentonite, attapulgite, magadiite, and kanemite. These may be used singly alone or in combination of two or more kinds thereof. Among them, from the viewpoint of the unevenness control, montmorillonite, bentonite, hectorite, and attapulgite are preferred, and in particular, montmorillonite having a charge imparting property is preferred.

From the viewpoint of the ease of inclusion in toner, a layered inorganic mineral obtained by modifying at least a part of ions existing between layers with organic ions (hereinafter, also simply referred to as “organic-modified layered inorganic mineral”) is preferably used. It is considered that when the organic-modified layered inorganic mineral is added, the viscous behavior of the liquid that contains a material constituting the toner has thixotropy, the viscosity is lowered and the particle size distribution is narrowed and homogenized during stirring, and the viscosity increases immediately when the stirring is stopped, and therefore, spheroidization due to interfacial tension is prevented and the shape during stirring can be maintained.

Herein, the expression “modifying - - - with organic ions” means that organic ions are introduced into the ions existing between the layers. This is called intercalation in a broad sense. As the organic-modified layered inorganic mineral, an organic-modified layered inorganic mineral obtained by modifying the above-described layered inorganic mineral with an organic cation is desired.

As the organic cation modifier of the organic-modified layered inorganic mineral, a quaternary alkyl ammonium salt, a phosphonium salt, an imidazolium salt, and the like can be mentioned, and a quaternary alkyl ammonium salt is desired. Examples of the quaternary alkyl ammonium include trimethylstearyl ammonium, dimethylstearylbenzyl ammonium, dimethyloctadecyl ammonium, and oleyl bis(2-hydroxyethyl)methyl ammonium.

As a commercially available product of the layered inorganic mineral obtained by modifying a part with organic ions, quaternium-18 bentonite such as Bentone 3, Bentone 38, and Bentone 38V (these are manufactured by Rheox, Inc.), TIXOGEL VP (manufactured by United Catalyst Inc.), and CLAYTON (registered trademark) 34, CLAYTON (registered trademark) 40 and CLAYTON (registered trademark) XL (these are manufactured by Southern Clay Product Inc.); stearalkonium bentonite such as Bentone 27 (manufactured by Rheox, Inc.), TIXOGEL LG (manufactured by United Catalyst Inc.), and CLAYTON (registered trademark) AF and CLAYTON (registered trademark) APA (these are manufactured by Southern Clay Product Inc.); quaternium 18benzalkonium bentonite such as CLAYTON (registered trademark) HT, and CLAYTON (registered trademark) PS (these are manufactured by Southern Clay Product Inc.); and GARAMITE 1958 and LAPONITE (registered trademark) 1958RD (these are manufactured by BYK Japan KK) can be mentioned. Particularly preferably CLAYTON (registered trademark) AF, CLAYTON (registered trademark) APA, and LAPONITE (registered trademark) 1958RD can be mentioned.

The layered inorganic mineral is contained in the toner material in an amount of preferably 0.1 to 10.0% by mass, and more preferably 0.5 to 5% by mass. Within the above range, the shape of the toner can be changed without impairing the characteristics of the toner.

(Coloring Agent)

The toner base particles of the present invention may contain a coloring agent. The coloring agent that can be used in the present invention is not particularly limited and a known coloring agent may be used. These coloring agents may be used alone or in combination of two or more kinds selected therefrom as needed.

As the coloring agent of black, for example, a carbon black such as a furnace black, a channel black, an acetylene black, a thermal black, and a lamp black, and further magnetic powder of magnetite, ferrite or the like can also be used.

As the coloring agent for magenta or red, there are C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 60, C.I. Pigment Red 63, C.I. Pigment Red 64, C.I. Pigment Red 68, C.I. Pigment Red 81, C.I. Pigment Red 83, C.I. Pigment Red 87, C.I. Pigment Red 88, C.I. Pigment Red 89, C.I. Pigment Red 90, C.I. Pigment Red 112, C.I. Pigment Red 114, C.I. Pigment Red 122, C.I. Pigment Red 123, C.I. Pigment Red 139, C.I. Pigment Red 144, C.I. Pigment Red 149, C.I. Pigment Red 150, C.I. Pigment Red 163, C.I. Pigment Red 166, C.I. Pigment Red 170, C.I. Pigment Red 177, C.I. Pigment Red 178, C.I. Pigment Red 184, C.I. Pigment Red 202, C.I. Pigment Red 206, C.I. Pigment Red 207, C.I. Pigment Red 209, C.I. Pigment Red 222, C.I. Pigment Red 238, C.I. Pigment Red 269, and the like.

Further, as the coloring agent for orange or yellow, there are C.I. Pigment Orange 31, C.I. Pigment Orange 43, C.I. Pigment Yellow 12, C.I. Pigment Yellow 14, C.I. Pigment Yellow 15, C.I. Pigment Yellow 17, C.I. Pigment Yellow 74, C.I. Pigment Yellow 83, C.I. Pigment Yellow 93, C.I. Pigment Yellow 94, C.I. Pigment Yellow 138, C.I. Pigment Yellow 155, C.I. Pigment Yellow 162, C.I. Pigment Yellow 180, C.I. Pigment Yellow 185, and the like.

Furthermore, as the coloring agent for green or cyan, there are C.I. Pigment Blue 2, C.I. Pigment Blue 3, C.I. Pigment Blue 15, C.I. Pigment Blue 15:2, C.I. Pigment Blue 15:3, C.I. Pigment Blue 15:4, C.I. Pigment Blue 16, C.I. Pigment Blue 17, C.I. Pigment Blue 60, C.I. Pigment Blue 62, C.I. Pigment Blue 66, C.I. Pigment Green 7, and the like.

Moreover, as the dye, C.I. Solvent Red 1, C.I. Solvent Red 49, C.I. Solvent Red 52, C.I. Solvent Red 58, C.I. Solvent Red 63, C.I. Solvent Red 111, C.I. Solvent Red 122, C.I. Solvent Yellow 2, C.I. Solvent Yellow 6, C.I. Solvent Yellow 14, C.I. Solvent Yellow 15, C.I. Solvent Yellow 16, C.I. Solvent Yellow 19, C.I. Solvent Yellow 21, C.I. Solvent Yellow 33, C.I. Solvent Yellow 44, C.I. Solvent Yellow 56, C.I. Solvent Yellow 61, C.I. Solvent Yellow 77, C.I. Solvent Yellow 79, C.I. Solvent Yellow 80, C.I. Solvent Yellow 81, C.I. Solvent Yellow 82, C.I. Solvent Yellow 93, C.I. Solvent Yellow 98, C.I. Solvent Yellow 103, C.I. Solvent Yellow 104, C.I. Solvent Yellow 112, C.I. Solvent Yellow 162, C.I. Solvent Blue 25, C.I. Solvent Blue 36, C.I. Solvent Blue 60, C.I. Solvent Blue 70, C.I. Solvent Blue 93, C.I. Solvent Blue 95, and the like.

The use amount of the coloring agent is in the range of preferably 1 to 30% by mass, and more preferably 2 to 20% by mass relative to the total amount of toner. The number average primary particle diameter of the coloring agent varies depending on the kind, but is preferably around 10 to 200 nm in general.

(Release Agent)

The toner base particles of the present invention may contain a release agent.

As the release agent, it is not particularly limited, and various known waxes, for example, a polyolefin wax such as polyethylene wax, and polypropylene wax, a branched chain hydrocarbon wax such as microcrystalline wax, a long chain hydrocarbon-based wax such as paraffin wax, and sasol wax, a dialkyl ketone-based wax such as distearyl ketone, an ester-based wax such as carnauba wax, montan wax, behenyl behenate, trimethylolpropane tribehenate, pentaerythritol tetrabehenate, pentaerythritol diacetate dibehenate, glycerin tribehenate, 1,18-octadecanediol distearate, trimellitic acid tristearyl, and distearyl maleate, and an amide-based wax such as ethylenediamine behenylamide, and trimellitic acid tristearylamide, may be used. By constituting the toner as containing the releasing agent in this way, the fixability of the toner is improved.

The addition amount of the release agent is preferably 0.1 to 30 parts by mass, and more preferably 1 to 15 parts by mass relative to 100 parts by mass of the toner. When the addition amount of the release agent is 0.1 parts by mass or more relative to 100 parts by mass of the toner, the addition amount is preferred from the viewpoint of the suppression of image defects due to the peeling failure of the fixing member and the image. When the addition amount of the release agent is 30 parts by mass or less relative to 100 parts by mass of the toner, the addition amount is preferred in that favorable image quality can be obtained.

(External Additive)

An external additive may also be allowed to adhere to the surfaces of toner base particles for the purpose of controlling the flowability and the chargeability.

As the external additive, conventionally known metal oxide particles can be used, and for example, silica particles, titania particles, alumina particles, zirconia particles, zinc oxide particles, chromium oxide particles, cerium oxide particles, antimony oxide particles, tungsten oxide particles, tin oxide particles, tellurium oxide particles, manganese oxide particles, and boron oxide particles can be mentioned. These may be used alone or in combination of two or more kinds thereof.

With respect to the silica particles, silica particles prepared by a sol-gel method can be used. The silica particles prepared by a sol-gel method have a feature that the particle size distribution is narrow, and therefore, are preferred from the viewpoint of suppressing the variations of the adhesion strength. The number average primary particle diameter of the silica particles formed by a sol-gel method is preferably 70 to 150 mm The silica particles having a number average primary particle diameter within the range described above have a particle diameter larger than that of other external additives, and therefore, have a role as a spacer, and have an effect of preventing other external additives having a small particle diameter from being embedded into the toner base particles by stirring and mixing the external additives in a developing machine, and further have an effect of preventing the toner base particles from being fused to one another.

In addition, organic fine particles of a homopolymer of styrene, methyl methacrylate or the like, a copolymer thereof, and the like may be used as an external additive.

The metal oxide particles used as an external additive are preferably metal oxide particles, the surfaces of which have been hydrophobized with a known surface treatment agent such as a coupling agent. As the surface treatment agent, dimethyldimethoxysilane, hexamethyldisilazane (HMDS), methyltrimethoxysilane, isobutyltrimethoxysilane, decyltrimethoxysilane, or the like is preferred.

Further, as the surface treatment agent, a silicone oil can also be used. Specific examples of the silicone oil include a cyclic compound such as an organosiloxane oligomer, octamethylcyclotetrasiloxane, decamethylcyclopentasiloxane, tetramethylcyclotetrasiloxane, and tetravinyltetramethylcyclotetrasiloxane, and a straight or branched organosiloxane. In addition, a silicone oil that is highly reactive and has at least a modified end, in which a modifying group is introduced into a side chain, one end, both ends, one side chain end, both side chain ends, or the like may be used. Examples of the modifying group include an alkoxy group, a carboxyl group, a carbinol group, modification with higher fatty acid, a phenol group, an epoxy group, a methacrylic group, and an amino group, but the modifying group is not particularly limited. Further, for example, a silicone oil having several kinds of modifying groups of amino/alkoxy modification may also be accepted.

Further, a mixing treatment or a combination treatment may be performed using a dimethyl silicone oil and the above-described modified silicone oil, and further other surface treatment agents. Examples of the treatment agent to be used in combination include a silane coupling agent, a titanate-based coupling agent, an aluminate-based coupling agent, various kinds of silicone oils, a fatty acid, a fatty acid metal salt, an esterification product thereof, and rosin acid.

In order to further improve the cleaning performance and the transferability, a lubricant may be used as an external additive. For example, the following metal salt of higher fatty acid such as a salt of zinc, aluminum, copper, magnesium, calcium, or the like of stearic acid, a salt of zinc, manganese, iron, copper, magnesium, or the like of oleic acid, a salt of zinc, copper, magnesium, calcium, or the like of palmitic acid, a salt of zinc, calcium, or the like of linoleic acid, and a salt of zinc, calcium, or the like of recinoleic acid can be mentioned.

The total addition amount of these external additives is preferably 0.1 to 10 parts by mass, and more preferably 1 to 5 parts by mass relative to 100 parts by mass of toner base particles.

The toner according to the present invention may have a core-shell structure from the viewpoint of improving the low temperature fixability and the heat-resistant storability. The core-shell structure is not limited to a structure in which the core particle is completely coated with a shell layer, and for example, may be a structure in which the core particle is exposed in some areas without being completely coated with a shell layer.

The core-shell structure can be confirmed by observing the structure in a cross section of the toner using, for example, a known means such as a transmission electron microscope (TEM), and a scanning probe microscope (SPM).

<Production Method of Toner Particles>

The toner particles according to the present invention can be produced by the following procedures. However, herein, it is merely to disclose an example of the production methods, and the present invention is not limited to the following production method examples.

(1) Preparation Step of Binder Resin

In a case of using a styrene-(meth)acrylic copolymer resin as a component of the binder resin, the styrene-(meth)acrylic copolymer resin is produced. As the production method of the styrene-(meth)acrylic copolymer resin, as already described in the description concerning the binder resin, the description is omitted here.

In a case of using a urea-modified polyester resin as a component of the binder resin, firstly, a prepolymer of the urea-modified polyester resin is produced. Specifically, polyol and polycarboxylic acid are heated to preferably 150 to 280° C. in the presence of a catalyst such as dibutyltin oxide, generated water is distilled off under reduced pressure as needed, and a polyester having a hydroxyl group is produced. Next, the produced polyester is reacted with a polyisocyanate compound preferably at a temperature of 40 to 140° C., and a prepolymer having an isocyanate group is obtained. Further, in the (4) Reaction step of polyester prepolymer described later, amines are reacted with the prepolymer to produce a polyester resin modified with a urea bond.

In a case of using an unmodified polyester resin in combination as a component of the binder resin, the unmodified polyester resin can be produced by a production method similar to that of the polyester having a hydroxyl group.

(2) Preparation Step of Toner Material Liquid

This step is a step of preparing a toner material liquid by dispersing toner constituent materials such as a binder resin, a layered inorganic mineral, and a coloring agent in an organic solvent.

As the organic solvent used for preparing the toner material liquid, an organic solvent having volatility at a boiling point lower than 100° C. is preferred from the viewpoint of the easy removal after formation of toner base particles, and specifically, methyl acetate, ethyl acetate, methyl ethyl ketone, methyl isobutyl ketone, toluene, xylene, and the like can be used alone, or in combination of two or more kinds thereof.

In the present step, a method of dispersing all of the toner constituent materials at the same time in a toner material liquid, a method of dispersing the toner constituent materials separately in several times, a method of adding a layered inorganic mineral in the (3) Emulsification step of toner material liquid described later, or the like can be employed, and the method is not particularly limited as long as the toner material liquid can be uniformly dispersed.

In the case of adding a coloring agent, the coloring agent may be added after being compounded with a resin to form a masterbatch. The resin is not particularly limited, and may be appropriately selected from the known resins depending on the intended purpose. Examples of the resin include a polymer of styrene or a substitution product thereof, a styrene-based copolymer, a polymethyl methacrylate resin, a polybutyl methacrylate resin, a polyvinyl chloride resin, a polyvinyl acetate resin, a polyethylene resin, a polypropylene resin, a polyester resin, an epoxy resin, an epoxy polyol resin, a polyurethane resin, a polyamide resin, a polyvinyl butyral resin, a polyacrylic acid resin, rosin, modified rosin, a terpene resin, an aliphatic hydrocarbon resin, an alicyclic hydrocarbon resin, an aromatic petroleum resin, chlorinated paraffin, and paraffin. These may be used singly alone or in combination of two or more kinds thereof.

(3) Emulsification Step of Toner Material Liquid

This step is a step of adding and dispersing the above-described toner material liquid into an aqueous medium to prepare toner base particles to be a toner particle raw material, and the toner material liquid emulsified and dispersed in the aqueous medium has a predetermined particle diameter.

As the aqueous medium that can be used for the emulsification and dispersion of the toner material liquid, in addition to water alone, an aqueous medium containing an organic solvent such as alcohols (methanol, isopropyl alcohol, ethylene glycol, and the like), dimethylformamide, tetrahydrofuran, cellosolves (methyl cellosolve, and the like), and lower ketones (acetone, methyl ethyl ketone, and the like) may be used.

Further, in order to improve the dispersibility of the toner material liquid, a dispersant such as a surfactant, resin fine particles, or the like may be added into the aqueous medium.

As the method of the dispersion, the method is not particularly limited, and known equipment of low speed shear type, high speed shear type, friction type, high pressure jet type, ultrasonic waves, or the like may be applied. Among them, in order to make the particle diameter of the dispersion element 2 to 20 μm, the high-speed shear type is preferred. In a case of using the high-speed shear-type disperser, the number of revolutions is not particularly limited, and is generally 1000 to 30000 rpm, and preferably 5000 to 20000 rpm. The dispersion time is not particularly limited, and is generally 0.1 to 30 minutes in a case of a batch system. The temperature at the time of dispersion is generally 0 to 150° C. (under pressure).

(4) Reaction Step of Polyester Prepolymer

This step is a step of adding polyvalent amines into an emulsion prepared in the emulsification step of toner material liquid, reacting the resultant mixture with a polyester prepolymer in the toner material liquid, producing a polyester resin that is a binder resin constituting the toner, and preparing a dispersion liquid of toner base particles.

Note that this step is described separately from the above-described emulsification step of toner material liquid, however, actually, at the same time as the emulsification and dispersion in the emulsification step of toner material liquid, amines are added to perform a reaction with a polyester prepolymer having an isocyanate group.

This reaction involves crosslinking or elongating the molecular chain of the polyester. The reaction time may be set on the basis of the reactivity of an isocyanate group structure possessed by the polyester prepolymer with amines, and is preferably 10 minutes to 40 hours, and more preferably 2 to 24 hours specifically. Further, the reaction temperature is preferably 0 to 150° C., and more preferably 40 to 98° C. Furthermore, a catalyst such as dibutyltin laurate, and dioctyltin laurate may be used as needed.

(5) Washing Step

This step is a step of cooling the dispersion liquid of toner base particles obtained in the above, separating the toner base particles from the dispersion liquid of toner base particles after cooling by solid-liquid separation, and removing the surfactant and the like from the toner base particles. That is, in this step, the toner base particles are solid-liquid separated from the dispersion liquid of toner base particles after the completion of deformation treatment to form a toner cake, and an adhered substance such as the surfactant is removed from the obtained toner cake. Specific examples of the solid-liquid separation and washing method include a centrifugal separation method, a vacuum filtration method using Nutsche or the like, and a filtration method using a filter press or the like, and these are not particularly limited.

(6) Drying Step

This step is a step of performing a drying treatment on the toner base particles that have been washed in the washing step. As a dryer usable in this drying step, a spray dryer, a vacuum freezing dryer, a reduced-pressure dryer, a stationary shelf dryer, a movable shelf dryer, a fluidized bed dryer, a rotary dryer, a stirring-type dryer, or the like can be mentioned, and these are not particularly limited. In addition, the amount of moisture in the dry-treated colored particles is preferably 5% by mass or less, and furthermore preferably 1% by mass or less.

(7) Addition Step of External Additive

This addition step of external additive is a step of adding an external additive such as a charge control agent, and various inorganic fine particles, organic fine particles, or lubricants into the thy-treated toner base particles for the purpose of improving the flowability, the chargeability, the cleaning performance, and the like, and is performed as needed. As the device used for adding an external additive, various known mixing devices such as a turbula mixer, a Henschel Mixer, a Nauta mixer, a V-type mixer, and a sample mill can be mentioned. In addition, in order to make the particle size distribution of the toner within an appropriate range, sieve classification may be performed as needed.

<Physical Properties of Toner Particles>

(Average Particle Diameter)

The average particle diameter of the toner (toner particles) according to the present invention is preferably 3 to 10 μm in volume median diameter. If the average particle diameter is 3 μm or more, the chargeability of the carrier is hardly lowered due to spent. If the average particle diameter is 10 μm or less, the scattering of the toner can be suppressed.

The volume median diameter (D50) of the toner (toner particles) can be measured and calculated using a device in which a computer system for data processing is connected to “Multisizer 3” (manufactured by Beckman Coulter, Inc.). As the measurement procedure, 0.02 g of toner particles is allowed to be blended with 20 ml of a surfactant solution (for example, a surfactant solution prepared by diluting a neutral detergent containing a surfactant component 10 times with pure water for the purpose of dispersing the toner particles), and then the resultant mixture is subjected to ultrasonic dispersion for 1 minute to prepare a dispersion liquid of toner particles. This dispersion liquid of toner particles is injected with a pipette into a beaker in which “ISOTON II” (manufactured by Beckman Coulter, Inc.) has been placed in the sample stand until the measured concentration reaches 5 to 10%, and the count of a measuring machine is set to 25000 to perform the measurement. Note that Multisizer 3 having an aperture diameter of 100 μm is used. The range of 1 to 30 μm, which is the measurement range, is divided into 256 to calculate the frequency value, and the particle diameter corresponding to 50% from the larger volume-integrated fraction is determined as the volume median diameter (D50).

The volume average particle diameter of the toner (toner particles) can be controlled by controlling the concentration of the flocculant, the amount of the organic solvent to be added, the fusion time, or the like in the above-described production method.

(Average Circularity)

The average circularity of the toner (toner particles) according to the present invention is preferably 0.920 to 0.980. In the range as described above, a toner that is more easily charged is obtained. The average circularity of the toner (toner particles) can be controlled by controlling the temperature, time, and the like during the aging treatment in the above-described production method.

The average circularity can be measured using, for example, a flow-type particle image analyzer “FPIA-3000” (manufactured by SYSMEX CORPORATION). Specifically, the measurement can be performed by the following method. The toner particles are wetted with an aqueous surfactant solution, the wetted toner is subjected to ultrasonic dispersion for 1 minute to be dispersed. After that, the measurement is performed using “FPIA-3000”, in a measurement condition HPF (high power focusing) mode at an appropriate concentration of HPF detection number 3000 to 10000, and the circularity of each particle is calculated by the following equation. The calculated value of the circularity of each particle is added up, and then a value obtained by dividing the added-up value by the total number of the measured particles is the average circularity.

Circularity=(circumference length of a circle having an area equivalent to the projection area of a particle)/(circumference length of a projection image of a particle) [Mathematical formula 1]

[Carrier]

The carrier according to the present invention contains core material particles and a coating layer with which at least a part of surfaces of the core material particles is coated.

Hereinafter, the constitution of the carrier will be described separately for the core material particles and the coating layer.

<Coating Layer>

The coating layer of the carrier of the two-component developer according to the present invention contains a coating resin.

The coating resin contains a resin A having a constituent unit derived from a (meth)acrylate monomer, and the (meth)acrylate monomer contains an alicyclic (meth)acrylate monomer.

The coating resin may consist of the resin A, and may further contain a resin B in addition to the resin A.

Further, the resin A may consist of the constituent unit derived from a (meth)acrylate monomer, and may contain a constituent unit other than the constituent unit derived from a (meth)acrylate monomer.

In addition, the (meth)acrylate monomer may consist of the alicyclic (meth)acrylate monomer, and may further contain a chain (meth)acrylate monomer.

(Resin A)

The resin A in the coating resin contains at least a constituent unit derived from an alicyclic (meth)acrylate monomer.

As the alicyclic (meth)acrylate monomer, an alicyclic (meth)acrylate monomer that contains a cycloalkyl ring having 3 to 12 carbon atoms is preferred, and examples of the alicyclic (meth)acrylate monomer include cyclopropyl methacrylate, cyclobutyl methacrylate, cyclopentyl methacrylate, cyclohexyl methacrylate, cycloheptyl methaciylate, cyclooctyl methacrylate, and cyclodecyl methacrylate. Among them, from the viewpoint of the stress relaxation at the time of collision with the toner, an alicyclic (meth)acrylate monomer having an 8- to 12-membered alicyclic group with more carbon atoms is more preferred. That is, the constituent unit derived from the alicyclic (meth) acrylate monomer contained in the resin A preferably contains an 8- to 12-membered alicyclic group. These alicyclic (meth)acrylate monomers may be used singly alone or in combination of two or more kinds thereof.

In addition, the resin A may contain a constituent unit derived from a (meth)acrylate monomer other than the constituent unit derived from an alicyclic (meth)acrylate monomer, for example, a constituent unit derived from a chain (meth)acrylate monomer. Specific examples of the chain (meth)acrylate monomer include methyl methaciylate, ethyl methaciylate, propyl methacrylate, n-butyl methacrylate, hexyl methacrylate, octyl methacrylate, and 2-ethylhexyl methacrylate. Among them, from the viewpoint of the improvement of the abrasion resistance and the chargeability, it is preferred to contain methyl methacrylate. These chain (meth)acrylate monomers may be used singly alone or in combination of two or more kinds thereof.

Further, in the resin A, a constituent unit derived from a monomer (also referred to as “other monomers”) other than the above-described alicyclic (meth)acrylate monomer and chain (meth)acrylate monomer may be contained. Specific example of other monomers includes a vinyl monomer such as styrene, vinyl acetate, and vinyl chloride. These other monomers may be used singly alone or in combination of two or more kinds thereof.

The content of the constituent unit derived from the alicyclic (meth)acrylate monomer in the resin A is preferably 10 to 100% by mass, and more preferably 50 to 100% by mass when the total amount of the constituent units derived from the monomers (refer to “alicyclic (meth)acrylate monomer”, “chain (meth)acrylate monomer”, and “other monomers”, the same applies hereinafter) constituting the resin A is 100% by mass When the content is within the above-described range, the stress relaxation effect on the toner is improved.

The polymerization initiator used in forming the resin A is not particularly limited, and water-soluble radical initiator can be used. Among them, an azo compound having a nitrogen atom as the substituent (compound that has a structure having an azo group, and containing a nitrogen atom as the substituent) is preferred. For example, 2,2′-azobisisobutyronitrile, 2,2′-azobis(2,4-dimethylvaleronitrile), 2,2′-azobis(4-methoxy-2,4-dimethylvaleronitrile), dimethyl 2,2′-azobisisobutyrate, 4,4′-azobis(4-cyanopentanoic acid), 2,2′-azobis(2-amidinopropane) dihydrochloride, 2,2′-azobis-(N-N′-dimethyleneisobutylamidine), and 2,2′-azobis-(N-N′-dimethyleneisobutylamidine) dihydrochloride can be mentioned.

Note that it can be determined by confirming the presence of a nitrogen atom by an X-ray analyzer (ESCA) that the resin A has prepared using an azo compound having a nitrogen atom as the substituent as the polymerization initiator.

As the preparation method of the resin A, there are no particular limitations, and for example, a method in which into a reaction vessel equipped with a stirring device, a temperature sensor, a cooling pipe, and a nitrogen introduction device, an alicyclic methacrylic acid ester monomer, and an aqueous surfactant solution or a solvent are charged, into the mixed mixture, a polymerization initiator that is an azo compound having a nitrogen atom as the substituent is added, and the resultant mixture is heated and stirred to perform the polymerization can be mentioned.

The volume average primary particle diameter of the resin A is preferably 0.05 to 5 μm, and in the range as described above, the resin particles melt by heating, and a uniform resin coating layer is formed. A resin A having a weight average molecular weight (Mw) of 50,000 to 500,000 is preferably used, and in the range as described above, the strength of the resin coating layer becomes appropriate, and the surfaces of the carrier particles are refreshed by abrasion.

The volume average particle diameter of the resin A is a value obtained as measured by a dynamic light scattering method using a known “Microtrac UPA-150 (manufactured by NIKKISO CO., LTD.)”. Specifically, the measurement is performed by the following procedure. First, in a 50-ml graduated cylinder, a few drops of resin fine particles for measurement were added dropwise, and 25 ml of pure water was added, and the resultant mixture is dispersed for 3 minutes using an ultrasonic washing machine “US-1 (manufactured by AS ONE Corporation)” to prepare a sample for measurement. Next, 3 ml of the sample for measurement is charged in a cell of “Microtrac UPA-150”, and it is confirmed that the value of Sample Loading is in the range of 0.1 to 100. Subsequently, the measurement is performed under the following conditions.

Measurement Conditions

Transparency: Yes

Refractive Index: 1.59

Particle Density: 1.05 g/cm³

Spherical Particles: Yes

Solvent Conditions

Refractive Index: 1.33

Viscosity:
High (temp) 0.797×10⁻³ Pa·S
Low (temp) 1.002×10⁻³ Pa·S.

Note that the weight average molecular weight of the resin A is measured using gel permeation chromatography (GPC) under the following conditions. That is, the measurement sample is dissolved in tetrahydrofuran so that the concentration is 1 mg/mL. As for the dissolution conditions, the measurement is performed using an ultrasonic disperser at room temperature for 5 minutes. Next, the resultant mixture is treated with a membrane filter having a pore size of 0.2 μm, and then 10 μL of a sample solution is injected into the GPC. In the molecular weight measurement of a sample, a molecular weight distribution of the sample is calculated using a calibration curve obtained by the measurement using monodispersed polystyrene standard particles. Ten polystyrene samples are used for the calibration curve measurement.

Measurement Conditions of GPC

Device: HLC-8220 (manufactured by TOSOH CORPORATION)

Column: TSK guard column+TSK gel Super HZM-M 3 series (manufactured by TOSOH CORPORATION)

Column temperature: 40° C.

Solvent: Tetrahydrofuran

Flow rate: 0.2 mL/min

Detector: Refractive index detector (RI detector).

(Resin B)

The coating resin may further contain a resin B in addition to the above-described resin A. Specific examples of the resin B include a silicone resin, and a modified silicone resin, and among them, a silicone resin is preferably used. As the resin B, a synthesized product may be used, or a commercially available product may also be used. By further containing the resin B, the coating layer of the carrier is hardly peeled off, and the actual printing durable charge stability is improved.

As an example of the commercially available silicone resins, for example, KR271, KR255, and KR152 manufactured by Shin-Etsu Chemical Co., Ltd., SR2400, SR2441, SR2440, and SR2406 manufactured by Dow Corning Toray Silicone Co., Ltd., and the like can be mentioned. As an example of the commercially available modified silicone resins, for example, KR5206 (alkyd modified), KR9706 (acrylic modified), and ES1001N (epoxy modified) manufactured by Shin-Etsu Chemical Co., Ltd., and the like can be mentioned.

The coating resin may include only the resin A, and the resin A and the resin B may be included at the same time from the viewpoint of the actual printing durable charge stability. In the case of including the resin A and the resin B at the same time, the mass ratio of the resin A : the resin B is preferably 20:80 to 80:20, and more preferably 30:70 to 70:30.

(Others)

In addition to the above-described coating resin, a coating layer may contain charge control particles, conductive particles, and the like as needed.

Examples of the charge control particles include strontium titanate, calcium titanate, magnesium oxide, an azine compound, a quarternary ammonium salt, and triphenylmethane. The addition amount of the charge control particles in the coating resin is preferably 2 to 40 parts by mass in a case of strontium titanate, calcium titanate, and magnesium oxide, and 0.3 to 10 parts by mass in a case of an azine compound, a quaternary ammonium salt, and triphenylmethane.

Further, examples of the conductive particles include carbon black, zinc oxide, and tin oxide. The addition amount of the low-resistance fine particles in the coating resin is preferably 2 to 40 parts by mass for carbon black, 2 to 150 parts by mass for zinc oxide, and 2 to 200 parts by mass for tin oxide.

In addition, as long as the coating layer has favorable adhesion to the core material particles and has abrasion resistance, there is no problem even if the resin used for forming the coating layer is formed in a uniform layer form, or formed by fixing in a form of particles.

<Core Material Particles>

The carrier of the present invention contains core material particles. The core material particles are constituted of, for example, various kinds of ferrites, and the like in addition to metal powder such as iron powder. Among them, ferrite is preferred.

As the ferrite, a ferrite containing a heavy metal such as copper, zinc, nickel, and manganese, or a light metal ferrite containing an alkali metal or an alkaline earth metal is preferred.

Ferrite is a compound represented by formula: (MO)ₓ(Fe₂O₃)_{y}, and the mole ratio “y” of the Fe₂O₃ constituting the ferrite is preferably 30 to 95% by mole. In the range as described above, there is an advantage such that a carrier that easily obtains desired magnetization and hardly causes carrier adhesion can be prepared, and the like. M in the formula is a metal atom such as manganese (Mn), magnesium (Mg), strontium (Sr), calcium (Ca), titanium (Ti), copper (Cu), zinc (Zn), nickel (Ni), aluminum (Al), silicon (Si), zirconium (Zr), bismuth (Bi), cobalt (Co), and lithium (Li), and those described above can be used singly alone, or in combination of multiple kinds thereof. Among them, from the viewpoint that the residual magnetization is low and suitable magnetic characteristics can be obtained, manganese, magnesium, strontium, lithium, copper, and zinc are preferred, and manganese, magnesium, and strontium are more preferred.

As the core material particles, a commercially available product or a synthetic product may be used. As the synthesis method, for example, the following method can be mentioned.

At first, an appropriate amount of a raw material is weighed, and then the raw material is pulverized and mixed with a wet media mill, a ball mill, a vibration mill, or the like for preferably 0.5 hours or more, and more preferably 1 to 20 hours. The pulverized material thus obtained is pelletized using a pressure molding machine or the like, and then the pelletized material is temporarily fired at a temperature of preferably 700 to 1200° C. for preferably 0.5 to 5 hours.

Without using the pressure molding machine, after the pulverization of the raw material, water is added into the pelletized material to obtain a slurried material, and the obtained slurried material may be granulated using a spray dryer. After temporary firing, the temporarily fired material is further pulverized with a ball mill, a vibration mill, or the like, and then into the pelletized material, water, and if necessary, a dispersant, a binder such as polyvinyl alcohol (PVA), and the like are added to adjust the viscosity and to perform the granulation, subsequently normal firing is performed. The temperature of the normal firing is preferably 1000 to 1500° C., the time of the normal firing is preferably 1 to 24 hours, and the oxygen concentration during the normal firing is preferably 0.5 to 5% by volume. When pulverizing after the temporary firing, the temporarily fired material may be pulverized with a wet ball mill, a wet vibration mill, or the like after addition of water.

The pulverizer such as the above-mentioned ball mill or vibration mill is not particularly limited, and in order to effectively and uniformly disperse the raw materials, it is preferred to use fine beads having a particle diameter of 1 cm or less in a medium to be used. Further, by adjusting the diameter, composition, and pulverization time of the beads to be used, the degree of the pulverization can be controlled.

The fired material thus obtained is pulverized and classified. The particle size is adjusted to a desired particle diameter using an existing air classification method, mesh filtration method, precipitation method, or the like as the classification method.

After that, if necessary, an oxide coating treatment is applied by heating the surface at low temperature, and the resistance adjustment can be performed. In the oxide coating treatment, using a general rotary electric furnace, a batch-type electric furnace, or the like, for example, a heat treatment can be performed at 300 to 700° C. The thickness of the oxide coating formed by this treatment is preferably 0.1 nm to 5 μm. By setting the thickness of the oxide coating in the range described above, an effect of the oxide coating layer is obtained, and desired characteristics can be easily obtained without having extremely high resistance, and therefore, this is preferred. If necessary, reduction may be performed before the oxide coating treatment. In addition, after the classification, low magnetic products may further be separated by magnetic separation.

The shape factor (SF-1) of core material particles is preferably 110 to 140, and more preferably 120 to 130. In the range as described above, the coating material can have the distribution of the thickness. In the part where the coating material is thin, the volume resistivity of the carrier is lowered by the core material particles having low resistance properties, and therefore, electrons are easy to move and excessive charging under low temperature and low humidity is suppressed. Further, in the part where the coating material is thick, the electric charge can be retained, and therefore, decrease in the charge amount under high temperature and high humidity is suppressed. That is, in the range described above, a carrier with a small environmental difference in the charge amount can be obtained. Such a carrier can impart a constant charge amount to the toner even if the temperature and humidity environment changes.

The shape factor SF-1 of core material particles can be adjusted by changing the composition ratio of the raw materials, the degree of pulverization, the condition at firing (temperature, oxygen concentration, and the like).

The shape factor (SF-1) of core material particles is a numerical value calculated by the following equation.

Equation: SF-1={(MXLNG)²/(AREA)}×(π/4)×100 [Mathematical formula 2]

In the above equation, the expression “MXLNG” indicates the maximum diameter of the core material particles, and the expression “AREA” indicates the projection area of the core material particles. Herein, the maximum diameter means a width at which a distance between parallel lines becomes the maximum when a projection image of the core material particle on a plane is sandwiched between the two parallel lines. Further, the projection area is an area of a projection image of the core material particle on a plane. The maximum diameter and projection area of the core material particle can be obtained by the following measurement method.

That is, 100 or more core material particles, which have been randomly selected, are photographed at 150 times with a scanning electron microscope, the photographed images are taken into a scanner, and measured using an image processing analyzer LUZEX (registered trademark) AP (manufactured by NIRECO CORPORATION). The shape factor of core material particles is a value calculated as an average value of the shape factors of the respective core material particles calculated by the above-described equation 1.

The average particle diameter of the core material particles is preferably 15 to 80 μm, and more preferably 20 to 70 μm as the median diameter (D50) on a volume basis. In the range as described above, a sufficient contact area with the toner can be ensured, and a toner image with high image quality can be stably formed. The median diameter (D50) can be measured by a laser diffraction particle size analyzer “HELOS & RODOS” (manufactured by Sympatec GmbH) equipped with a wet-type disperser.

The saturation magnetization of the core material particles is preferably 1.0×10⁻⁴ to 2.5×10⁻⁵ Wb·m/kg. By using a carrier having such a magnetic characteristic, partial aggregation hardly occurs in the carrier. For this reason, the two-component developer is uniformly dispersed on a surface of a developer conveying member, and a uniform and high-precision toner image can be formed without generating density unevenness. Residual magnetization can be reduced by using ferrite. In addition, when the residual magnetization is small, the flowability of the carrier itself becomes favorable, and a two-component developer having a uniform bulk density can be obtained.

<Adhesion of Coating Resin to Core Material Particles>

As the method for preparing a coating layer by coating surfaces of core material particles with a coating resin, a wet coating method, and a dry coating method can be mentioned, and these can be used in combination.

In one embodiment of the present invention, in a case of containing only the resin A as the coating resin, a dry coating method is preferably used. In a case of a dry coating method, the amount of the resin disposed in a concave part of core material particles increases, and the amount of the resin disposed in a convex part decreases. Therefore, the volume resistivity of the carrier can be appropriately lowered, and the environmental difference in the charge amount can be reduced. Further, in addition to the effect of the distribution of the thickness of the resin coating layer, by filling the concave part with the resin, the shape of the carrier particle becomes close to a spherical shape and further the flowability is improved.

In another embodiment of the present invention, in a case of containing the resin A and the resin B as the coating resin, a wet coating method is preferably used. In a case of a wet coating method, the resin B such as a silicone resin can be applied more uniformly.

Hereinafter, each method will be described.

(Dry Coating Method)

As an example of the dry coating method, a method in which surfaces of core material particles are coated with a coating resin by applying mechanical impact or heat can be mentioned, and it is preferred to be a coating method including the following steps.

1: Core material particles to be coated, a coat material in which coating resin particles and a solid matter (for example, resin particles) to be added as needed have been dispersed are mechanically stirred, and the coat material is allowed to adhere to the surfaces of the core material particles.

2: After that, the coating resin particles in the coat material adhered to the surfaces of the core material particles are melted or softened and fixed by applying mechanical impact or heat, and a coat layer (coating layer) is formed.

3: If necessary, the steps 1 and 2 are repeated to form a coat layer having a desired thickness.

As the device used for the method of coating by applying mechanical impact or heat, for example, a high speed stirring mixer with horizontal stirring blades, or an attrition mill having a rotor and a liner, such as a turbo mill (manufactured by FREUND-TURBO CORPORATION), a pin mill, and KRYPTRON (these are manufactured by Kawasaki Heavy Industries, Ltd.) can be mentioned, and a high speed stirring mixer with horizontal stirring blades is preferably used.

In a case of performing the coating under heating, the heating temperature is preferably 60 to 130° C., more preferably 80 to 120° C., and furthermore preferably 100 to 120° C. Further, the heating time is preferably 10 to 120 minutes, more preferably 20 to 90 minutes, and furthermore preferably 30 to 60 minutes. Under the heating conditions as described above, the aggregation among the coated carrier particles can be suppressed while melting the resin particles.

(Wet Coating Method)

(1) Fluidized Bed Type Spray Coating Method

The fluidized bed type spray coating method is a method in which a coating liquid prepared by dissolving a coating resin in a solvent is applied by spray coating onto surfaces of core material particles using a fluidized spray coating device, and then dried to prepare a coating layer.

(2) Immersion Type Coating Method

The immersion type coating method is a method in which core material particles are immersed in a coating liquid prepared by dissolving a coating resin in a solvent to perform a coating treatment, and then drying is performed to prepare a coating layer.

(3) Polymerization Method

The polymerization method is a method in which core material particles are immersed in a coating liquid prepared by dissolving a reactive compound in a solvent to perform a coating treatment, and then polymerization reaction is performed by applying heat or the like to prepare a coating layer.

The coating liquid is prepared preferably by mixing a coating resin into an appropriate solvent. The solid content concentration of the resin particles in the coating liquid is, as the total solid content concentration of the resin A and the resin B, preferably 5 to 50% by mass, more preferably 10 to 35% by mass, and furthermore preferably 15 to 25% by mass. In the range as described above, the amount of the coating resin to be applied onto the surfaces of the core material particles becomes an appropriate amount. Examples of the solvent to be suitably used for preparation of the coating liquid include an organic solvent such as toluene, xylene, methanol, ethanol, isopropanol, n-butanol, isobutanol, cyclohexane, n-hexane, methyl acetate, ethyl acetate, butyl acetate, isobutyl acetate, isopropyl acetate, acetone, methyl ethyl ketone, methyl isobutyl ketone, dimethylformamide, methyl cellosolve, and tetrahydrofuran, and water.

As the device used in the wet coating method, for example, COATMIZER (registered trademark) (manufactured by Freund Corporation), SPIRA COAT (manufactured by OKADA SEIKO CO., LTD.), or the like can be mentioned, and SPIRA COAT (manufactured by OKADA SEIKO CO., LTD.) is preferred because a coat layer can be favorably formed.

<Physical Properties of Carrier>

(Coating Thickness of Coating Layer)

The coating thickness of the coating layer is, from the viewpoint of achieving a balance between the durability of carrier and the adjustment of electric resistance value, preferably 0.2 to 4.0 μm, and more preferably 0.5 to 3.0 μm. The coating thickness of the coating layer is a value calculated by the following method.

Using a focused ion beam system “SMI 2050” (manufactured by Hitachi High-Tech Science Corporation), a carrier particle is cut at a plane passing through the center of the carrier particle to prepare a measurement sample. The cross section of the measurement sample is observed by a transmission electron microscope “JEM-2010F” (manufactured by JEOL Ltd.) with a field of view 5000 times, the value of the part having the maximum coating thickness and the value of the part having the minimum coating thickness in the field of view are measured, and the average value when the number of measurements is set to 50 is taken as the coating thickness of the resin coating layer. In addition, the resin used for forming a resin coating layer may be formed in the uniform layer form or formed by fixing in the form of particles as long as the resin coating layer has favorable adhesion to the core material particles and has abrasion resistance.

(Volume Resistivity)

The volume resistivity of the carrier according to the present invention is preferably 10⁷ to 10¹² Ω·cm, and more preferably 10⁸ to 10¹¹ Ω·cm. In the range as described above, the carrier is suitable also for high density toner image formation. Note that the volume resistivity is a resistance that is dynamically measured under developing conditions by a magnetic brush. Specifically, a photosensitive drum is replaced with an electrode drum made of aluminum having the same size as the photoreceptor drum, and carrier particles are supplied onto a developing sleeve to form a magnetic brush. This magnetic brush is rubbed with the electrode drum made of aluminum, a current flowing between the developing sleeve and the drum is measured by applying a voltage (500 V) between the developing sleeve and the drum, and thus, the volume resistivity of the carrier can be obtained by the following equation.

DVR(Ωcm)=(V/I)×(N×L/Dsd)

In the above equation, each abbreviation is as follows:

DVR: Volume resistivity (Q·cm)

V: Voltage between developing sleeve and drum (V)

I: Measured current value (A)

N: Developing nip width (cm)

L: Length of developing sleeve (cm)

Dsd: Distance between developing sleeve and drum (cm)

In the present specification, the measurement is performed with V=500 V, N=1 cm, L=6 cm, and Dsd=0.6 mm.

[Preparation of Two-Component Developer]

Next, the preparation of a two-component developer will be described.

The two-component developer can be prepared by mixing a carrier, and a toner.

In the mixing of a carrier and a toner, various known mixing devices such as a turbula mixer, a Henschel Mixer, a Nauta mixer, and a V-type mixer can be used.

The mixture ratio of the carrier and the toner is preferably 2 to 15 parts by mass of the toner relative to 100 parts by mass of the carrier. When the amount of the toner is 2 parts by mass or more relative to 100 parts by mass of the carrier, it is preferred from the viewpoint of securing the developability. When the amount of the toner is 15 parts by mass or less relative to 100 parts by mass of the carrier, it is preferred from the viewpoint of the charge stability.

### EXAMPLES

The effects of the present invention will be described using the following Examples and Comparative Examples. However, the technical scope of the present invention is not limited only to the following Examples. Note that in Examples, operation was carried out at room temperature (25° C.) unless otherwise specifically noted. Further, the expression of “parts” or “%” is used, and the “parts” or “%” represents “parts by mass” or “% by mass” unless otherwise specifically noted.

In addition, each of the measurement devices and methods in Examples is as follows.

Tg Measurement

The glass transition temperature (Tg) was measured using a DSC-7 differential scanning calorimeter (manufactured by PerkinElmer, Inc.), and a TAC7/DX thermal analyzer controller (manufactured by PerkinElmer, Inc.).

As the measurement procedure, 5.0 mg of toner was precisely weighed to two decimal places, and sealed in a pan made of aluminum (KITNO. 0219-0041), and the pan was set in a DSC-7 sample holder. Note that as the reference, an empty pan made of aluminum was used.

As the measurement conditions, the temperature control of Heat-Cool-Heat was performed at a measurement temperature of 0 to 200° C. at a temperature rise rate of 10° C./min, and a temperature drop rate of 10° C./min, and analysis was performed based on the data in the 2nd Heat.

As to the glass transition temperature, an extension line of the baseline before the rise of the first endothermic peak, and a tangent line showing the maximum inclination between the rising part and peak apex of the first peak were drawn, and the intersection was taken as the glass transition point.

Mw Measurement and Peak Molecular Weight

The weight average molecular weight and the peak molecular weight were measured as follows. Specifically, using a GPC device “HLC-8220” (manufactured by TOSOH CORPORATION) and a column “TSK guard column+TSK gel Super HZ-M 3 series” (manufactured by TOSOH CORPORATION), tetrahydrofuran (THF) was flowed as a carrier solvent at a flow rate of 0.2 ml/min while maintaining the column temperature at 40° C., and the measurement sample was dissolved in tetrahydrofuran so that the concentration becomes 1 mg/ml under the dissolving conditions in which the treatment was performed at room temperature for 5 minutes using an ultrasonic disperser.

Next, the resultant mixture was treated with a membrane filter having a pore size of 0.2 μm to obtain a sample solution, 10 μL of this sample solution was injected into the device together with the carrier solvent, detection was performed using a refractive index detector (RI detector), and a molecular weight distribution of the measurement sample was calculated using a calibration curve obtained by the measurement using monodispersed polystyrene standard particles. Ten polystyrene samples were used for the calibration curve measurement.

Mn Measurement

The number average molecular weight (Mn) was measured using a HLC-8120 GPC, SC-8020 device (manufactured by TOSOH CORPORATION) as the GPC device, TSK gel, Super HM-H (6.0 mm ID×15 cm×2) as the column, and tetrahydrofuran (THF) for chromatography manufactured by Wako Pure Chemical Industries, Ltd. as the eluent. The experiment was performed at a sample concentration of 0.5%, a flow rate of 0.6 ml/min, a sample injection volume of 10 μl, and a measurement temperature of 40° C. using an IR detector as the measurement conditions. Further, the calibration curve was prepared from 10 samples of “polystyrene standard sample, TSK standard” manufactured by TOSOH CORPORATION: A-500, F-1, F-10, F-80, F-380, A-2500, F-4, F-40, F-128, and F-700. The data collection interval in sample analysis was set to 300 ms.

“Preparation of Toner”

Preparation of Toner 1

(Synthesis of Organic Fine Particle Emulsion)

Into a reaction vessel equipped with a stirring bar and a thermometer, 683 parts of water, 11 parts of a sodium salt of a sulfuric acid ester of a methacrylic acid ethylene oxide adduct (ELEMINOL RS-30 manufactured by Sanyo Chemical Industries, Ltd.), 83 parts of styrene, 83 parts of methacrylic acid, 110 parts of butyl acrylate, and 1 part of ammonium persulfate were charged, the resultant mixture was stirred at 3800 rpm for 30 minutes, and a white emulsion was obtained. The resultant emulsion was heated to increase the system temperature up to 75° C., and was reacted for 4 hours. Further, into the resultant emulsion, 30 parts of a 1% ammonium persulfate aqueous solution was added, and aged at 75° C. for 6 hours to obtain an aqueous dispersion liquid [fine particle dispersion liquid 1] of a vinyl resin (a copolymer of styrene-methacrylic acid-butyl acrylate-a sodium salt of a sulfuric acid ester of a methacrylic acid ethylene oxide adduct). The volume average particle diameter of the [fine particle dispersion liquid 1] was 110 nm as measured by a laser diffraction/scattering particle size distribution measuring device (LA-920 manufactured by HORIBA Ltd.). Part of the [fine particle dispersion liquid 1] was dried and resin components were isolated therefrom. In the resin components, the Tg was 58° C., and the weight average molecular weight was 130,000.

(Preparation of Aqueous Phase)

990 parts of water, 83 parts of the [fine particle dispersion liquid 1], 37 parts of 48.3% aqueous solution of sodium dodecyl diphenyl ether disulfonate (ELEMINOL (registered trademark) MON-7 manufactured by Sanyo Chemical Industries, Ltd.), and 90 parts of ethyl acetate were mixed and stirred to obtain a milky white liquid. This was taken as an [aqueous phase 1].

(Synthesis of Unmodified Polyester 1)

In a reaction vessel equipped with a cooling pipe, a stirrer, and a nitrogen introduction pipe, 724 parts of an adduct of bisphenol A with 2 moles of ethylene oxide, and 276 parts of terephthalic acid were placed, the resultant mixture was polycondensed at 230° C. under normal pressure, and further the reaction was performed for 5 hours under a reduced pressure of 10 to 15 mmHg to obtain [unmodified polyester 1]. The [unmodified polyester 1] had a number average molecular weight of 2300, a weight average molecular weight of 6700, a peak molecular weight of 3800, a Tg of 43° C., and an acid value of 4.

(Synthesis of Intermediate Polyester 1)

In a reaction vessel equipped with a cooling pipe, a stirrer, and a nitrogen introduction pipe, 682 parts of an adduct of bisphenol A with 2 moles of ethylene oxide, 81 parts of an adduct of bisphenol A with 2 moles of propylene oxide, 283 parts of terephthalic acid, 22 parts of trimellitic anhydride, and 2 parts of dibutyl tin oxide were placed, the resultant mixture was reacted at 230° C. for 7 hours under normal pressure, and further reacted for 5 hours under a reduced pressure of 10 to 15 mmHg to obtain [intermediate polyester 1]. The [intermediate polyester 1] had a number average molecular weight of 2200, a weight average molecular weight of 9700, a peak molecular weight of 3000, a Tg of 54° C., an acid value of 0.5, and a hydroxyl value of 52.

Next, in a reaction vessel equipped with a cooling pipe, a stirrer, and a nitrogen introduction pipe, 410 parts of the [intermediate polyester 1], 89 parts of isophorone diisocyanate, and 500 parts of ethyl acetate were placed, and the resultant mixture was reacted at 100° C. for 5 hours to obtain [prepolymer 1].

(Synthesis of Ketimine)

In a reaction vessel equipped with a stirring bar and a thermometer, 170 parts of isophoronediamine, and 75 parts of methyl ethyl ketone were charged, and the resultant mixture was reacted at 50° C. for 4.5 hours to obtain a [ketimine compound 1]. The amine value of the [ketimine compound 1] was 417.

(Synthesis of Masterbatch)

800 Parts of water, 800 parts of carbon black (Printex 35 manufactured by Degussa Co.), [DBP oil absorption=42 ml/100 mg, pH=9.5], and 1200 parts of an unmodified polyester resin were added, and mixed by a Henschel Mixer (manufactured by Mitsui Mining Co., Ltd.), and the resultant mixture was kneaded at 130° C. for 2 hours using an open roll type kneader (Kneadex manufactured by manufactured by Mitsui Mining Co., Ltd.), then the kneaded mixture was rolled and cooled, and pulverized by a pulverizer to obtain a [masterbatch 1]. Note that water almost evaporated during the kneading.

(Preparation of Pigment-Wax Dispersion Liquid (Toner Material Liquid))

In a vessel equipped with a stirring bar and a thermometer, 300 parts of [unmodified polyester 1], 350 parts of paraffin wax (melting point of 70° C.), and 947 parts of ethyl acetate were charged, the resultant mixture was raised to 80° C. under stirring, kept at 80° C. for 5 hours, and then cooled to 30° C. in 1 hour. Next, in a vessel, 500 parts of the [masterbatch 1], 30 parts of organic-modified montmorillonite (CLAYTON (registered trademark) manufactured by Southern Clay Product Inc.), and 500 parts of ethyl acetate were charged, and the resultant mixture was mixed for 1 hour to obtain a [raw material solution 1].

1700 Parts of the [raw material solution 1] was transferred into the vessel, and carbon black and wax were dispersed using a bead mill (Ultra Visco Mill manufactured by AIMEX CO., Ltd.) under the conditions of a liquid sending speed of 1 kg/hr, a disc peripheral speed of 6 m/s, 0.5 mm zirconia beads packed at 80% by volume, and 3 passes. Next, into the resultant dispersion, 700 parts of a 65% ethyl acetate solution of the [unmodified polyester 1] was added, and 2 passes with a bead mill were performed under the above-described conditions to obtain a [pigment-wax dispersion liquid 1].

(Emulsification to Desolvation)

749 Parts of the [pigment-wax dispersion liquid 1], 100 parts of the [prepolymer 1], and 2.9 parts of the [ketimine compound 1] were placed in a vessel and mixed at 5,000 rpm for 2 minutes by a TK homomixer (manufactured by PRIMIX Corporation), and then 1500 parts of the [aqueous phase 1] was added in the vessel, and the resultant mixture was mixed at a revolution of 13,000 rpm for 25 minutes by a TK homomixer to prepare an [emulsion slurry 1].

In a vessel equipped with a stirrer and a thermometer, the [emulsion slurry 1] was charged, and was desolvated at 30° C. for 7 hours, and then aged at 45° C. for 7 hours to obtain a [dispersion slurry 1].

(Washing to Drying)

After 100 parts of the [dispersion slurry 1] was filtered under reduced pressure,

I: 100 Parts of ion exchanged water was added to a filter cake, and the resultant mixture was mixed (at a revolution of 12,000 rpm for 10 minutes) by a TK homomixer, and then filtered.

II: 100 Parts of 10% aqueous sodium hydroxide solution was added to the filter cake of I, and the resultant mixture was mixed (at a revolution of 12,000 rpm for 10 minutes) by a TK homomixer, and then filtered under reduced pressure.

III: 100 Parts of 10% hydrochloric acid was added to the filter cake of II, and the resultant mixture was mixed (at a revolution of 12,000 rpm for 10 minutes) by a TK homomixer, and then filtered.

IV: 300 Parts of ion exchanged water was added to the filter cake of III, and the ion exchanged water and the filter cake of III were mixed (at a revolution of 12,000 rpm for 10 minutes) by a TK homomixer, and then the mixture was filtered twice to obtain a [filter cake 1].

The [filter cake 1] was dried at 45° C. for 48 hours by an air circulating dryer, and sieved with a mesh with a mesh opening of 75 μm to obtain [toner base particles 1]. After that, to 100 parts of the [toner base particles 1], 1 part of hydrophobic silica, and 1 part of hydrophobic titanium oxide were mixed by a Henschel Mixer to obtain toner 1 of Example 1. Toner 1 had an average particle diameter of 6.1 μm and an average circularity of 0.958.

Preparation of Toner 2

A toner 2 was prepared using hectorite (LAPONITE (registered trademark) 1958RD manufactured by BYK Japan KK) in place of the organic-modified montmorillonite to be used in the preparation step of an oil layer in the preparation of toner 1. The toner 2 had an average particle diameter of 6.2 μm and an average circularity of 0.956.

Preparation of Toner 3

A toner 3 was prepared in the similar manner as in the toner 1 except that the organic-modified montmorillonite to be used in the preparation step of an oil layer was not added in the preparation method of toner 1. The toner 3 had an average particle diameter of 6.1 μm and an average circularity of 0.960.

Layered inorganic minerals in Toners 1 to 3 are summarized below.

TABLE 1

| Toner name | Layered inorganic mineral in toner |
|---|---|
| Toner 1 | Organic-modified montmorillonite |
| Toner 2 | Hectorite |
| Toner 3 | No layered inorganic mineral |

“Preparation of Carrier”

Preparation of Coating Resin

(Preparation of Resin A-1)

Into a reaction vessel equipped with a stirring device, a temperature sensor, a cooling pipe, and a nitrogen introduction device, 50 parts by mass of cyclohexyl methacrylate (hereinafter, also referred to as “CHMA”), 50 parts by mass of methyl methacrylate (hereinafter, also referred to as “MMA”), 100 parts by mass of toluene, and 100 parts by mass of methyl ethyl ketone were charged, and into the mixed mixture, 2.0 parts by mass of a polymerization initiator 2,2′-azobisisobutyronitrile (hereinafter, also referred to as “AIBN”) was added, and the resultant mixture was stirred at 70° C. for 8 hours for polymerization to prepare a resin A-1.

(Preparation of Resin A-2)

A resin A-2 was prepared using 50 parts by mass of cyclooctyl methacrylate (hereinafter, also referred to as “COMA”) in place of the 50 parts by mass of cyclohexyl methacrylate in the preparation of resin A-1.

(Preparation of Resin A-3)

A resin A-3 was prepared using 50 parts by mass of cyclodecyl methacrylate (hereinafter, also referred to as “CDMA”) in place of the 50 parts by mass of cyclohexyl methacrylate in the preparation of resin A-1.

(Preparation of Resin A-4)

A resin A-4 was prepared using 100 parts by mass of cyclohexyl methacrylate in place of the 50 parts by mass of cyclohexyl methacrylate and 50 parts by mass of methyl methacrylate in the preparation method of resin A-1.

Preparation of Carrier

(Preparation of Core Material Particles)

As the core material particles, Mn—Mg based ferrite particles having a volume average primary particle diameter of 55 μm and a saturation magnetization of 10.0×10⁵ Wb·m/kg were prepared.

(Preparation of Carrier 1)

1000 Parts by mass of the above-prepared “core material particles”, and 30 parts by mass of the “coating resin 1” were charged in a high speed stirring mixer with stirring blades, were mixed and stirred at 22° C. for 15 minutes under the condition that the peripheral speed of the horizontal rotor blade becomes 8 m/sec, and then further stirred and mixed at 120° C. for 30 minutes, and the surfaces of the core material particles were coated with a resin A-1 by the action of mechanical impact force to prepare a “carrier 1”.

(Preparation of Carriers 2 to 4)

Carriers 2 to 4 were prepared using the resin shown in Table 2 in place of the resin A-1 in the preparation of carrier 1.

(Preparation of Carrier 5)

| | |
|---|---|
| Resin A-4 | 9.0 parts by mass, |
| Resin B: silicone resin solution [solid content | 91.3 parts by mass, and |
| of 23% by mass (SR2440 manufactured by | |
| Dow Corning Toray Silicone Co., Ltd.)] | |
| Toluene | 90 parts by mass |

were dispersed for 10 minutes by a homomixer to obtain a coating layer forming solution 1.

Using 1000 parts by mass of Mn—Mg based ferrite particles having a volume average primary particle diameter of 55 μm and a saturation magnetization of 10.0×10⁵ Wb·m/kg as the core material particles, the surfaces of the core material particles were coated with the coating layer forming solution 1 with a SPIRA COTA (manufactured by OKADA SEIKO CO., LTD.) at a temperature inside the coater of 40° C., and dried. The obtained carrier was left to stand at 200° C. for 1 hour and fired in an electric furnace. After cooling, the ferrite powder bulk was pulverized using a sieve with a mesh opening of 63 μm to obtain a carrier 5.

(Preparation of Carriers 6 to 12)

Carriers 6 to 12 were prepared in the similar manner as in the preparation of carrier 5 except that the type and addition amount of the resin to be added into the coating layer forming solution 1 were changed to those as shown in Table 2.

“Preparation of Two-Component Developer”

Preparation of Developers 1 to 15

100 Parts by mass of a carrier and 6 parts by mass of a toner were charged in a V-type mixer, and mixed for 5 minutes under the environments of room temperature and normal humidity to prepare “developers 1 to 15”.

Combinations of the carrier and toner of the developers 1 to 15 are as shown in Table 2.

“Evaluation of Two-Component Developer”

Evaluation of Cleaning Performance

Under an environment of low temperature and low humidity (10° C., 20% RH), by replacing the developer with that as shown in Table 2 in bizhub Pro (registered trademark) 1200 (manufactured by Konica Minolta Business Technologies, Inc., currently KONICA MINOLTA, INC.), the following evaluation was performed by visual inspection for the toner slipping after continuous actual printing of 30000 sheets (A3 entire-surface solid image with an adhesion amount of 4 g/m²). Symbols ◯ and [symbol] were defined as acceptable levels.

[symbol] : Toner slipping is not observed at all, and there is no problem at all

◯: Toner slipping is observed, but there is no problem in practical use

×: Toner slipping is observed, and there is a practical problem (becomes image defects).

Evaluation of Charge Environmental Stability

A developer was charged in bizhub Pro (registered trademark) 1200 (manufactured by Konica Minolta Business Technologies, Inc., currently KONICA MINOLTA, INC.), and the charge amount (QL) of the developer after actual printing of 20000 sheets under an environment of low temperature and low humidity (10° C., 20% RH), and the charge amount (QH) of the developer after actual printing of 20000 sheets under high temperature and high humidity (33° C., 80% RH) were measured.

The charge amount is a value obtained by the following blow-off method.

The measurement of the charge amount by a blow-off method was performed using a blow-off charge amount measuring device “TB-200 (manufactured by Toshiba Chemical Co., Ltd.)”. The two-component developer to be measured was set in the above-described charge amount measuring device equipped with a 400-mesh stainless steel screen, and was blown with nitrogen gas for 10 seconds under the condition of a blow pressure of 50 kPa, and the charge was measured. The charge amount (μC/g) was calculated by dividing the measured charge by the scattered toner mass.

The charge amounts (QL) and (QH) of the developers 1 to 15 were determined, and |QL−Q| was calculated.

Evaluation of Toner Crush Resistance

The prepared developer was filled in a developing device for use in a multifunction machine, bizhub Pro (registered trademark) 1200 (manufactured by Konica Minolta Business Technologies, Inc., currently KONICA MINOLTA, INC.), and stirred at a speed of 600 rpm for 1 hour in a mono-unit driving device. After that, a small amount of the developer was collected, placed in a beaker, 0.1 g of a commercially available surfactant and 20 g of pure water were added in the beaker, and the beaker was shaken while applying a magnet from the lower side of the beaker to release the toner from the carrier. The supernatant was collected and the particle size distribution was measured by Multisizer 3 (manufactured by Beckman Coulter, Inc.). With respect to the developer after preparation of the developer, the particle size distribution of the supernatant was also measured in the similar way.

With respect to the number of particles of 4 am or less, the increase rate was calculated by subtracting the % by number of the particle size distribution after preparation of the developer from the % by number of the particle size distribution after stirring in the developing device, and used for the ranking as follows. Symbols [symbol] , ◯, and Δ were defined as acceptable levels.

[symbol] : Increase rate of the particles of 4 μm or less is less than 1%

◯: Increase rate of the particles of 4 μm or less is 1% or more and less than 3%

Δ: Increase rate of the particles of 4 μm or less is 3% or more and less than 5%

×: Increase rate of the particles of 4 μm or less is 5% or more

Evaluation of Fog Density

The developer was stirred for 1 hour after being prepared in the evaluation of toner crush resistance, and then was sequentially loaded in a multifunction machine, bizhub Pro (registered trademark) 1200 (manufactured by Konica Minolta Business Technologies, Inc., currently KONICA MINOLTA, INC.), and a solid white image was printed.

In the measurement of the fog density, firstly, absolute image densities at 20 points on an unprinted white paper sheet were measured using a Macbeth reflection densitometer “RD-918”, and averaged, the averaged value was taken as a white paper density. Next, absolute image densities at 20 points on the solid white image printed above were measured in the similar way, and averaged to obtain the average density, the value obtained by subtracting the white paper density from the above average density was evaluated as the fogging density. When the fog density is less than 0.010, it was evaluated as the acceptable level.

Evaluation of Actual Printing Durable Charge Stability

A developer was charged in bizhub Pro (registered trademark) 1200 (manufactured by Konica Minolta Business Technologies, Inc., currently KONICA MINOLTA, INC.), and continuous printing (a character chart corresponding to a printing ratio of 5%) and measurement of the charge amount of the developer were repeated as follows, and the printing durability (actual printing durable charge stability) was evaluated. At that time, the toner to be used for the developer was used as a replenishment toner.

Specifically, the charge amount (Qs) of the developer after printing of 1000 sheets under room temperature and normal humidity (temperature of 20° C., humidity of 50% RH) was measured, after that, the charge amount (Q₆₀) of the developer after 600 thousand sheets were printed under low temperature and low humidity (temperature of 10° C., relative humidity of 20% RH) and sequentially 1000 sheets were printed under normal temperature and normal humidity (temperature of 20° C., relative humidity of 50% RH) was measured, subsequently, again, the charge amount (Q₁₀₀) of the developer after 400 thousand sheets were printed under low temperature and low humidity (temperature of 10° C., relative humidity of 20% RH) and sequentially 1000 sheets were printed under normal temperature and normal humidity (temperature of 20° C., relative humidity of 50% RH) was measured, and |Qs−Q₁₀₀| was calculated.

The constitution and evaluation results of the two-component developers of Examples and Comparative Examples are shown in Table 2 below.

TABLE 2

| | | Constitution of developer | | | | |
|---|---|---|---|---|---|---|
| | | Carrier | | | | Toner |
| | | Carrier name | Resin A | Resin B | Resin A:Resin B | Toner name |
| Example 1 | Developer 1 | Carrier 4 | A-4 (CHMA only) | — | 100:0 | Toner 2 |
| Example 2 | Developer 2 | Carrier 4 | A-4 (CHMA only) | — | 100:0 | Toner 1 |
| Example 3 | Developer 3 | Carrier 12 | A-4 (CHMA only) | — | 100:0 | Toner 1 |
| Example 4 | Developer 4 | Carrier 5 | A-4 (CHMA only) | Silicone resin | 30:70 | Toner 1 |
| Example 5 | Developer 5 | Carrier 6 | A-1 (CHMA + MMA) | Silicone resin | 30:70 | Toner 1 |
| Example 6 | Developer 6 | Carrier 7 | A-1 (CHMA + MMA) | Silicone resin | 50:50 | Toner 1 |
| Example 7 | Developer 7 | Carrier 8 | A-1 (CHMA + MMA) | Silicone resin | 70:30 | Toner 1 |
| Example 8 | Developer 8 | Carrier 1 | A-1 (CHMA + MMA) | — | 100:0 | Toner 1 |
| Example 9 | Developer 9 | Carrier 8 | A-1 (CHMA + MMA) | Silicone resin | 70:30 | Toner 2 |
| Example 10 | Developer 10 | Carrier 9 | A-2 (COMA + MMA) | Silicone resin | 70:30 | Toner 1 |
| Example 11 | Developer 11 | Carrier 2 | A-2 (COMA + MMA) | — | 100:0 | Toner 1 |
| Example 12 | Developer 12 | Carrier 10 | A-3 (CDMA + MMA) | Silicone resin | 70:30 | Toner 1 |
| Example 13 | Developer 13 | Carrier 3 | A-3 (CDMA + MMA) | — | 100:0 | Toner 1 |
| Comparative | Developer 14 | Carrier 11 | — | Silicone resin | 0:100 | Toner 1 |
| Example 1 | | | | | | |
| Comparative | Developer 15 | Carrier 8 | A-1(CHMA + MMA) | Silicone resin | 70:30 | Toner 3 |
| Example 2 | | | | | | |

| | Evaluation | | | | |
|---|---|---|---|---|---|
| | | Charge | | | Actual printing |
| | | environmental | Evaluation of | | durable charge |
| | Evaluation of | stability | toner crush | Evaluation of | stability |
| | cleaning | \| Q_{L}-Q_{H} \| | resistance | fog density | \| Q_{S}-Q₁₀₀ \| |
| Example 1 | ◯ | 15 | ◯ | 0.04 | 21 |
| Example 2 | ⊙ | 13 | ◯ | 0.05 | 22 |
| Example 3 | ⊙ | 13 | ◯ | 0.05 | 22 |
| Example 4 | ⊙ | 26 | Δ | 0.08 | 9 |
| Example 5 | ⊙ | 25 | Δ | 0.08 | 9 |
| Example 6 | ⊙ | 22 | Δ | 0.07 | 11 |
| Example 7 | ⊙ | 18 | Δ | 0.06 | 13 |
| Example 8 | ⊙ | 9 | ◯ | 0.05 | 17 |
| Example 9 | ◯ | 18 | ◯ | 0.06 | 12 |
| Example 10 | ⊙ | 17 | ◯ | 0.05 | 12 |
| Example 11 | ⊙ | 8 | ⊙ | 0.03 | 16 |
| Example 12 | ⊙ | 17 | ⊙ | 0.03 | 12 |
| Example 13 | ⊙ | 8 | ⊙ | 0.02 | 16 |
| Comparative | ⊙ | 36 | X | 0.13 | 6 |
| Example 1 | | | | | |
| Comparative | X | 26 | ◯ | 0.09 | 12 |
| Example 2 | | | | | |

From the evaluation results in Table 2, the following can be understood.

From the comparison of Example 7 and Comparative Example 2, it was suggested that by containing a layered inorganic mineral in a toner, the cleaning performance of a photoreceptor is improved. In addition, as can be seen from the results of Examples 1 and 2, better evaluation results were obtained in a case where the layered inorganic mineral in a toner was montmorillonite. Further, from the results of Examples 5 to 8, as the content of the silicone resin in the coating layer of a carrier was increased, the charge environment stability was slightly decreased, on the other hand, the actual printing durable charge stability was improved. This is considered to be because when the content of the silicone resin is increased, moisture absorption by the silicone resin is increased, but the coating layer of the carrier is hardly peeled off and the actual printing durable charge stability is improved. Therefore, the output of the image was able to be stably high quality even in mass printing.

From the results of Examples 7, 8, and 10 to 13, in the constituent unit derived from the alicyclic (meth) acrylate monomer contained in a resin A, when the number of carbon atoms of the alicyclic group was increased, the toner crush resistance and the fog density were improved. The reason for this is considered that when the number of carbon atoms of the alicyclic group is increased, the stress relaxation effect becomes prominent at the time of collision of the carrier with the toner, and the toner hardly cracks. Moreover, from the results of Comparative Example 1, it has also been found that in the case where the coating layer of a carrier does not have a constituent unit derived from an alicyclic (meth)acrylate monomer, the crush resistance and fog density of the toner are poor.

As described above, from the evaluation results shown in Table 2, it has been found that the two-component developer of Examples is a two-component developer that improves the cleaning performance of a photoreceptor, hardly generates toner cracks, is excellent in the charge environmental stability, and can output high-quality images stably even in mass printing.

Although embodiments of the present invention have been described and illustrated in detail, the disclosed embodiments are made for purposes of illustration and example only and not limitation. The scope of the present invention should be interpreted by terms of the appended claims.

What is claimed is:

1. A two-component developer comprising:
a toner containing a binder resin and a layered inorganic mineral; and
a carrier containing core material particles and a coating layer with which at least a part of surfaces of the core material particles is coated,
the coating layer containing a coating resin,
the coating resin containing a resin A having a constituent unit derived from a (meth)acrylate monomer, and
the (meth)acrylate monomer containing an alicyclic (meth)acrylate monomer.

2. The two-component developer according to claim 1, wherein
the coating resin consists of the resin A.

3. The two-component developer according to claim 2, wherein
the resin A is a resin consisting of the constituent unit derived from a (meth)acrylate monomer.

4. The two-component developer according to claim 3, wherein
the resin A is a resin consisting of the constituent unit derived from the alicyclic (meth)acrylate monomer.

5. The two-component developer according to claim 1, wherein
the (meth)acrylate monomer further contains a chain (meth)acrylate monomer.

6. The two-component developer according to claim 1, wherein
the constituent unit derived from the alicyclic (meth)acrylate monomer has an 8- to 12-membered alicyclic group.

7. The two-component developer according to claim 1, wherein
the coating resin further contains a resin B other than the resin A.

8. The two-component developer according to claim 7, wherein
the resin B is a silicone resin.

9. The two-component developer according to claim 7, wherein
in the coating resin, a mass ratio of the resin A to the resin B is 20:80 to 80: 20.

10. The two-component developer according to claim 1, wherein
the layered inorganic mineral is montmorillonite.

11. The two-component developer according to claim 1, wherein
the layered inorganic mineral is a layered inorganic mineral obtained by modifying at least a part of ions existing between layers with organic ions.
